(19) United States
(12) Patent Application Publication
(10) Pub. No.: US 2020/0232552 A1
(43) Pub. Date: Jul. 23, 2020

(54) PLANETARY GEAR SUPPORT SHAFT AND PLANETARY GEAR DEVICE

(71) Applicant: JTEKT CORPORATION, Osaka (JP)

(72) Inventors: Kotaro YAMASHITA, Kashiwara-shi (JP); Kazuyuki KOTANI, Toyota-shi (JP); Tomohiro HIROKAWA, Anjo-shi (JP); Shoshi SUEMITSU, Anjo-shi (JP); Makoto HAMANO, Anjo-shi (JP)

(73) Assignee: JTEKT CORPORATION, Osaka (JP)

(21) Appl. No.: 16/743,281

(22) Filed: Jan. 15, 2020

(30) Foreign Application Priority Data
Jan. 21, 2019 (JP) 2019-007822

(51) Int. Cl. F16H 57/04

(52) U.S. Cl. CPC F16H 57/043; F16H 2001/2872

(57) ABSTRACT

A planetary gear support shaft is provided in a shaft hole of a planetary gear to support the planetary gear. The planetary gear is disposed between an internal gear and an external gear supported coaxially so as to be rotatable relative to each other. The planetary gear support shaft includes a body made of a tubular steel pipe with two open ends, and a pair of lid bodies that block opening portions at the two ends of the body. The body has an in-flow hole that allows lubricating oil to flow into a hollow portion between the pair of lid bodies and an out-flow hole through which the lubricating oil is supplied from the hollow portion into the shaft hole.

### CROSS-REFERENCE TO RELATED APPLICATION

This application claims priority to Japanese Patent Application No. 2019-007822 filed on Jan. 21, 2019, incorporated herein by reference in its entirety.

### BACKGROUND

### 1. Technical Field

The present disclosure relates to a planetary gear support shaft that supports a planetary gear, and to a planetary gear device that includes the planetary gear support shaft.

### 2. Description of Related Art

A planetary gear device that includes an internal gear and an external gear (sun gear) supported coaxially so as to be rotatable relative to each other, a plurality of planetary gears (planetary gears) disposed between the internal gear and the external gear, a carrier that supports the plurality of planetary gears so as to be rotatable and revolvable, and roller bearings that allow the planetary gears to rotate smoothly is used for shifting in a drive system of a vehicle, for example (see Japanese Unexamined Patent Application Publication No. 2005-321026 (JP 2005-321026 A), for example).

The carrier of the planetary gear device described in JP 2005-321026 A has a pair of annular plates that interpose the plurality of planetary gears in the axial direction and a plurality of support shafts inserted through the respective central portions of the plurality of planetary gears. The roller bearing, in which a plurality of needle rollers are held by a cage, is disposed between the planetary gear and the support shaft. Two end portions of the support shaft are fitted into through holes provided in the pair of annular plates, and prevented from rotating. The support shaft is made of a steel material in a circular column shape, and provided with a hollow hole formed from one shaft end surface. The hollow hole is a blind hole which does not penetrate the support shaft. An opening portion at one end of the support shaft is blocked by a plug.

The plug is formed by drawing into a bottomed cylindrical shape, by disposing a plug raw material in a flat plate shape at an opening end surface of the hollow hole of the support shaft and press-fitting the plug raw material into the hollow hole by punching. The support shaft is formed with a lubricating oil supply inlet hole for introducing lubricating oil into the hollow hole, and a lubricating oil supply outlet hole for supplying the lubricating oil which is introduced into the hollow hole to the roller bearing. A side surface of one of the pair of annular plates is formed with an oil groove that communicates with the lubricating oil supply inlet hole. The lubricating oil is introduced from the oil groove into the hollow hole via the lubricating oil supply inlet hole by a centrifugal force due to rotation of the carrier. The plug suppresses leakage of the lubricating oil which is introduced into the hollow hole.

### SUMMARY

Because of a rise in environmental awareness in recent years, it is requested more eagerly than ever to reduce the weight of in-vehicle devices mounted on vehicles. In the planetary gear device configured as described above, the weight of the support shaft can be reduced by increasing the capacity of the hollow hole by increasing the axial depth of the hollow hole, for example. Since the lubricating oil leaks out if the distal end portion of the hollow hole penetrates the support shaft when the hollow hole is being formed, however, there is a constraint on the increase in the capacity of the hollow hole. In a processing method in which a hollow hole is formed in a steel material in a circular column shape and a plug is press-fitted into the hollow hole, meanwhile, metal powder tends to be produced during processing. If such metal powder remains in the hollow hole, smooth rotation of planetary gears may be affected. Thus, a step of fully cleaning the inside of the hollow hole after the plug is attached is required.

The present disclosure aims at weight reduction and easy manufacture.

A first aspect of the present disclosure provides a planetary gear support shaft. The planetary gear support shaft is inserted through a shaft hole of a planetary gear to support the planetary gear. The planetary gear is disposed between an internal gear and an external gear supported coaxially so as to be rotatable relative to each other. The planetary gear support shaft includes: a body that is a tubular steel pipe with two open ends; and a pair of lid bodies that block opening portions at the two ends of the body. The body has an in-flow hole that allows lubricating oil to flow into a hollow portion between the pair of lid bodies and an out-flow hole through which the lubricating oil is supplied from the hollow portion into the shaft hole.

With the above configuration, it is possible to reduce the weight of the planetary gear support shaft and facilitate manufacture.

A second aspect of the present disclosure provides a planetary gear device. The planetary gear device includes: an internal gear and an external gear supported coaxially so as to be rotatable relative to each other; a planetary gear disposed between the internal gear and the external gear; a carrier that supports the planetary gear so as to be rotatable and revolvable; and a roller bearing that allows the planetary gear to rotate smoothly. The carrier includes a frame body provided coaxially with the internal gear and the external gear so as to be rotatable relative thereto, and a support shaft attached to the frame body to support the planetary gear. The support shaft is inserted through a shaft hole of the planetary gear to support the planetary gear. The support shaft includes a body that is a tubular steel pipe with two open ends, and a pair of lid bodies that block opening portions at the two ends of the body. The body has an in-flow hole that allows lubricating oil to flow into a hollow portion between the pair of lid bodies and an out-flow hole through which the lubricating oil is supplied from the hollow portion into the shaft hole.

With the above configuration, it is possible to reduce the weight of the planetary gear support shaft and facilitate manufacture.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view illustrating a planetary gear device in which a planetary gear support shaft according to a first embodiment is used;

FIG. 2A is an axial sectional view, taken along the axial direction, illustrating a planetary gear and the support shaft;

FIG. 2B is a cross-sectional view taken along the line IIB-IIB in FIG. 2A;

FIG. 3 includes a sectional view of the support shaft on the left side of the drawing, and a front view of the support shaft as seen in the axial direction on the right side of the drawing;

FIG. 4 illustrates a state before and after a step of attaching a first lid body to a body of the support shaft on the left and right sides, respectively, of the drawing;

FIG. 5 includes a sectional view of a support shaft according to a second embodiment on the left side of the drawing, and a front view of the support shaft as seen in the axial direction on the right side of the drawing; and

FIG. 6 illustrates a state before and after a step of fixing a first lid body to a body of the support shaft on the left and right sides, respectively, of the drawing.

### DETAILED DESCRIPTION OF EMBODIMENTS

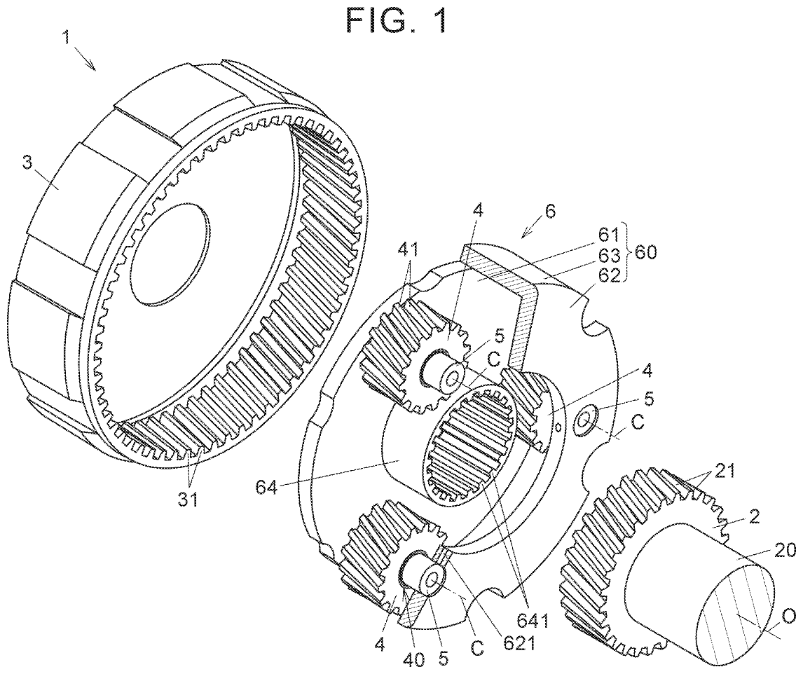

An embodiment of the present disclosure will be described with reference to FIGS. 1 to 4. The embodiments described below are provided as suitable specific examples for carrying out the present disclosure, and include portions that specifically implement a variety of technical matters that are technically preferable. However, the technical scope of the present disclosure is not limited to such a specific aspect.

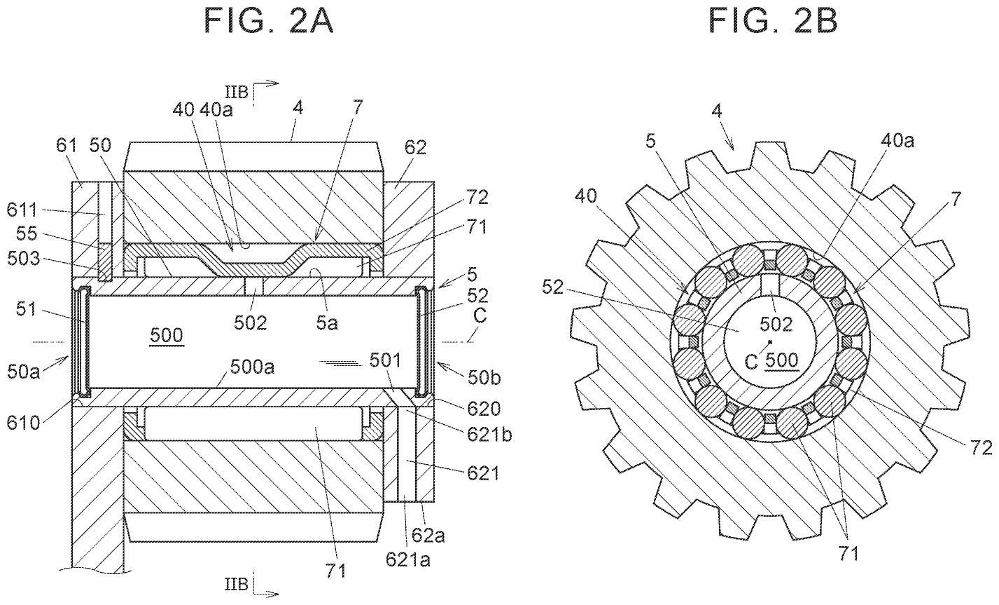

FIG. 1 is an exploded perspective view illustrating a planetary gear device in which a planetary gear support shaft (hereinafter referred to as a “support shaft”) according to the present embodiment is used. FIG. 2A is an axial sectional view, taken along the axial direction, illustrating a planetary gear and the support shaft. FIG. 2B is a cross-sectional view taken along the line IIB-IIB in FIG. 2A.

A planetary gear device 1 includes: a sun gear 2 that has external teeth 21 on the outer peripheral surface thereof; an internal gear 3 that has internal teeth 31 on the inner peripheral surface thereof; a plurality of (three in the present embodiment) planetary gears 4 disposed between the sun gear 2 and the internal gear 3 and having external teeth 41 meshed with the external teeth 21 and the internal teeth 31; a carrier 6 that includes a plurality of (three) support shafts 5 that support the plurality of planetary gears 4, respectively; and roller bearings 7 disposed between the plurality of planetary gears 4 and the plurality of support shafts 5. The sun gear 2, the internal gear 3 and the carrier 6 are supported coaxially so as to be rotatable relative to each other.

The planetary gear device 1 is used in a transmission that changes the speed of rotation of a rotary shaft (crankshaft) of an engine that serves as a drive source of an automobile, for example. When torque is input to one of the three elements of the planetary gear device 1, namely the sun gear 2, the internal gear 3, and the carrier 6, with a second one of the elements fixed, the input torque is transferred to the remaining one element with the speed reduced or increased. When the various portions of the planetary gear device 1 slide, such portions are lubricated with lubricating oil (transmission oil).

A shaft 20 is fixed to the central portion of the sun gear 2 so as not to be relatively rotatable. The sun gear 2 is disposed concentrically with the internal gear 3 and the carrier 6. The support shaft 5 is inserted through a shaft hole 40 that penetrates the central portion of the planetary gear 4. The planetary gear 4 is supported by the support shaft 5 via the roller bearing 7. The roller bearing 7 has a plurality of needle rollers 71 and a cage 72 that holds the plurality of needle rollers 71. The needle rollers 71 roll on an inner peripheral surface 40a of the shaft hole 40 of the planetary gear 4 and an outer peripheral surface 5a of the support shaft 5.

In the case where the shaft 20 is rotated with the internal gear 3 fixed, rotation of the sun gear 2 which is rotated together with the shaft 20 is reduced and output to an output shaft (not illustrated) which rotates together with the carrier 6. In this event, the plurality of planetary gears 4 revolve around a rotational axis O of the shaft 20, and each rotate about a central axis C of the support shaft 5. Hereinafter, the direction which is parallel to the central axis C will be referred to as the “axial direction”.

The carrier 6 is composed of a frame body 60 provided coaxially with the sun gear 2 and the internal gear 3 so as to be rotatable relative thereto about the rotational axis O, and the plurality of (three in the present embodiment) support shafts 5. The frame body 60 has first and second annular plates 61 and 62 which are a pair of plate portions that interpose the plurality of planetary gears 4 in the axial direction, a crosslinking wall 63 that bridges respective end portions of the first and second annular plates 61 and 62 on the radially outer side, and a fitting tube 64 fixed to an end portion of the first annular plate 61 on the radially inner side. A plurality of spline protrusions 641 are formed on the inner periphery of the fitting tube 64. The output shaft described above is inserted through the fitting tube 64 to be spline-fitted, for example.

The support shaft 5 has a body 50 made of a tubular steel pipe with two open ends, and a pair of lid bodies 51 and 52 that block opening portions 50a and 50b at the two ends of the body 50. A first end portion, in the axial direction, of the body 50 is fitted with a fitting hole 610 formed in the first annular plate 61. A second end portion, in the axial direction, of the body 50 is fitted with a fitting hole 620 formed in the second annular plate 62. Hereinafter, the opening portion 50a on the side of the first annular plate 61, of the opening portions 50a and 50b at the two ends, will be referred to as a “first opening portion 50a”, and the opening portion 50b on the side of the second annular plate 62 will be referred to as a “second opening portion 50b”. The lid body 51 which blocks the first opening portion 50a will be referred to as a “first lid body 51”. The lid body 52 which blocks the second opening portion 50b will be referred to as a “second lid body 52”.

The body 50 is formed by performing processing, such as heat treatment or outer polishing, on a pipe-shaped body obtained by cutting a steel pipe as a raw material, which is formed in a pipe shape in advance, to a predetermined length. An example of the steel pipe includes a seamless steel pipe formed by a rolling mill and a sheet-rolled steel pipe formed by rolling a sheet material into a pipe shape using a pipe forming machine. The body 50 is formed with an in-flow hole 501 that allows lubricating oil to flow into a hollow portion 500 between the first and second lid bodies 51 and 52, and an out-flow hole 502 through which the lubricating oil is supplied from the hollow portion 500 into the shaft hole 40 of the planetary gear 4. The in-flow hole 501 is provided at an end portion of the body 50 on the side of the second opening portion 50b. The out-flow hole 502 is provided at the middle portion of the body 50 in the axial direction.

The second annular plate 62 is formed with an oil supply path 621 that communicates with the in-flow hole 501. A first end portion 621a of the oil supply path 621 opens in an inner peripheral surface 62a of the second annular plate 62. A second end portion 621b of the oil supply path 621 opens in the fitting hole 620. The lubricating oil which has entered the oil supply path 621 through the first end portion 621a flows because of a centrifugal force generated by rotation of the carrier 6 to flow into the in-flow hole 501 through the second end portion 621b. The in-flow hole 501 opens in the outer peripheral surface 5a of the support shaft 5 and an inner peripheral surface 500a of the hollow portion 500. The lubricating oil which has flowed in from the oil supply path 621 is supplied to the hollow portion 500 by way of the in-flow hole 501. In the present embodiment, the in-flow hole 501 is inclined with respect to the radial direction of the body 50 in order to avoid an annular groove 506 to be discussed later.

In the present embodiment, the oil supply path 621 of the second annular plate 62 is formed as a hole formed by drilling, for example. However, the present disclosure is not limited thereto, and the oil supply path 621 may be a groove formed in a surface of the second annular plate 62 on the planetary gear 4 side, for example. In the case where the rotational direction of the carrier 6 is fixed, the oil supply path 621 may be inclined with respect to the radial direction of the second annular plate 62 such that the second end portion 621b is positioned in rear of the first end portion 621a in the rotational direction in order that the lubricating oil can flow smoothly.

The lubricating oil which is supplied to the hollow portion 500 flows in the hollow portion 500, and flows out through the out-flow hole 502. The out-flow hole 502 is provided at the outermost position in the radial direction of the frame body 60, and opens in the inner peripheral surface 500a of the hollow portion 500 and the outer peripheral surface 5a of the support shaft 5. The lubricating oil which has flowed out through the out-flow hole 502 is supplied to the roller bearing 7, and lubricates sliding between the plurality of needle rollers 71 and the cage 72 etc.

A positioning fitting hole 503 is formed at an end portion of the body 50 on the first opening portion 50a side. A positioning pin 55 is fitted with the positioning fitting hole 503. The positioning pin 55 is press-fitted into a pin hole 611 formed in the first annular plate 61. The distal end portion of the positioning pin 55 is fitted into the fitting hole 503. The body 50 is prevented from rotating with respect to the frame body 60, and positioned in the axial direction, by the positioning pin 55.

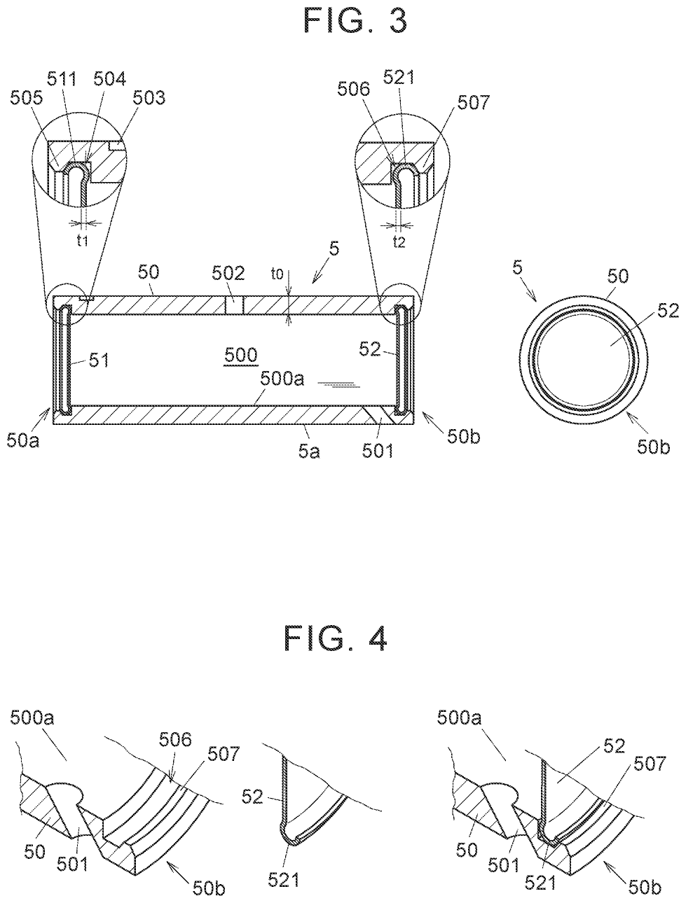

FIG. 3 includes a sectional view of the support shaft 5 on the left side of the drawing, and a front view of the support shaft 5 as seen in the axial direction on the right side of the drawing. FIG. 4 illustrates a state before and after a step of attaching the first lid body 51 to the body 50 of the support shaft 5 on the left and right sides, respectively, of the drawing.

The first and second lid bodies 51 and 52 are made of a thin plate made of metal that is thinner than a wall thickness t₀ of the body 50. More specifically, the first and second lid bodies 51 and 52 are made of SPC (cold-rolled steel) by pressing, for example, and respective wall thicknesses t₁ and t₂ of the first and second lid bodies 51 and 52 are 0.3 mm or more and less than 1.0 mm, for example. The first and second lid bodies 51 and 52 have a circular shape as seen in the axial direction of the support shaft 5. Curled portions 511 and 521 curved in an arcuate shape are formed at an end portion of the first and second lid bodies 51 and 52, respectively, on the outer peripheral side.

An annular groove 504 with which the first lid body 51 is fitted is formed in the inner peripheral surface of the body 50 at an end portion on the side of the first opening portion 50a. When the first lid body 51 is to be attached to the body 50, the curled portion 511 is elastically deformed to be accommodated in the annular groove 504. The first lid body 51 is prevented from slipping off from the body 50 with the curled portion 511 retained by an annular protrusion 505 that is adjacent to the annular groove 504. When the first lid body 51 is to be attached, the curled portion 511 is elastically deformed to climb over the protrusion 505. With the curled portion 511 formed, the first lid body 51 can be easily elastically reduced in diameter, and can be easily mounted to the annular groove 504.

Similarly, an annular groove 506 with which the second lid body 52 is fitted is formed in the inner peripheral surface of the body 50 at an end portion on the second opening portion 50b side. When the second lid body 52 is to be attached to the body 50, the curled portion 521 is elastically deformed to be accommodated in the annular groove 506. The second lid body 52 is prevented from slipping off from the body 50 with the curled portion 521 retained by an annular protrusion 507 that is adjacent to the annular groove 506. When the second lid body 52 is to be attached, the curled portion 521 is elastically deformed to climb over the protrusion 507. With the curled portion 521 formed, the second lid body 52 can be easily elastically reduced in diameter, and can be easily mounted to the annular groove 506.

It is desirable that the curled portions 511 and 521 of the first and second lid bodies 51 and 52 should tightly contact the inner surfaces of the annular grooves 504 and 506 over the entire circumference. If the amount of lubricating oil that leaks through the first and second opening portions 50a and 50b is minute, however, the curled portions 511 and 521 don't have to tightly contact the inner surfaces of the annular grooves 504 and 506. That is, the lubricating oil is permitted to leak out through the first and second opening portions 50a and 50b if an amount of lubricating oil that is necessary for the roller bearings 7 can be supplied. The work of fitting the first and second lid bodies 51 and 52 is performed by an automatic machine, for example, but can also be performed manually.

In the first embodiment described above, the first and second opening portions 50a and 50b of the body 50 of the support shaft 5 are blocked by the first and second lid bodies 51 and 52 which are each made of a thin plate. Thus, the weight of the support shaft 5 can be reduced compared to a case where a hollow hole is formed as in the support shaft for the planetary gear device according to the related art described above, for example. The first and second lid bodies 51 and 52 are elastically deformed to be fitted with the annular grooves 504 and 506 of the body 50. Thus, metal powder or burrs are not produced when the first and second lid bodies 51 and 52 are being attached. Therefore, there is no need to remove metal powder or burrs produced during press-fitting compared to a case where the openings of the support shaft are blocked by press-fitting plug bodies such as plugs, for example, which facilitates manufacture.

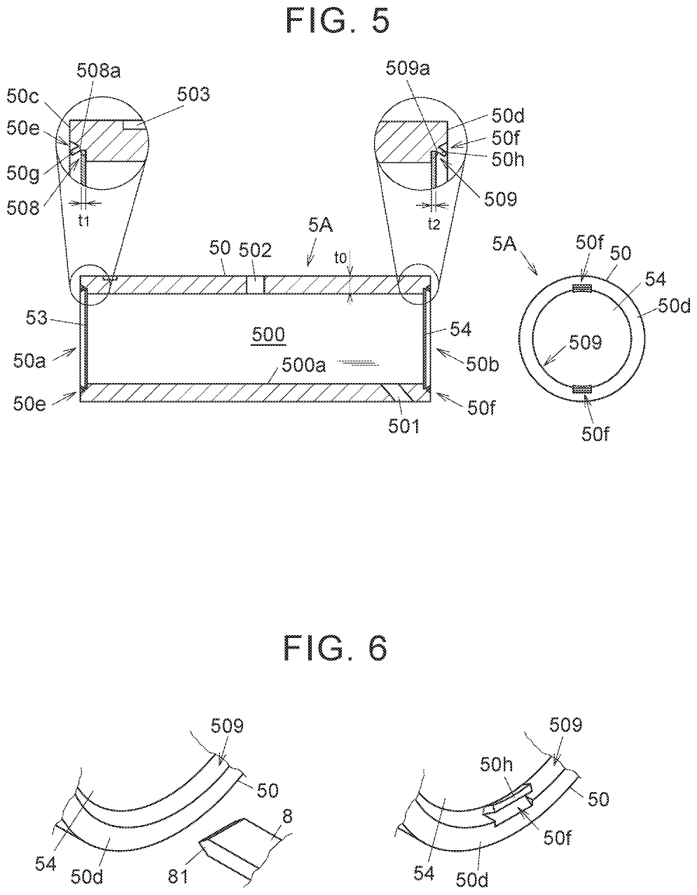

Next, a second embodiment will be described with reference to FIGS. 5 and 6. FIG. 5 includes a sectional view of a support shaft 5A according to a second embodiment on the left side of the drawing, and a front view of the support shaft 5A as seen in the axial direction on the right side of the drawing. FIG. 6 illustrates a state before and after a step of fixing a second lid body 54 to the body 50 of the support shaft 5A on the left and right sides, respectively, of the drawing.

While the first and second lid bodies 51 and 52 are fitted with the annular grooves 504 and 506 of the body 50 in the first embodiment, the first and second lid bodies 53 and 54 in a flat plate shape are fixed to the body 50 by clinching axial end surfaces 50c and 50d of the body 50 in the present embodiment. The first and second opening portions 50a and 50b of the body 50 are blocked by the first and second lid bodies 53 and 54.

The body 50 is made of a steel pipe as in the first embodiment. The first and second lid bodies 53 and 54 are made of a thin plate made of metal that is thinner than the wall thickness t₀ of the body 50. The first and second lid bodies 53 and 54 are obtained by punching a steel sheet of SPC (cold-rolled steel), for example, and the respective wall thicknesses t₁ and t₂ of the first and second lid bodies 53 and 54 are 0.3 mm or more and less than 1.0 mm, for example.

As in the first embodiment, the body 50 of the support shaft 5A is formed with the in-flow hole 501 and the out-flow hole 502 which open in the inner peripheral surface 500a of the hollow portion 500 and the outer peripheral surface 5a of the support shaft 5A. As in the first embodiment, the support shaft 5A is fixed to the frame body 60 by the positioning pin 55 (see FIG. 2A), which is fitted with the positioning fitting hole 503, to constitute the carrier 6.

In the present embodiment, the first and second opening portions 50a and 50b of the body 50 are formed with annular notches 508 and 509 for attachment of the first and second lid bodies 53 and 54, respectively. The notches 508 and 509 are formed such that the inside diameter thereof is larger than the inside diameter of the hollow portion 500 between the first and second lid bodies 53 and 54 and slightly larger than the diameter of the first and second lid bodies 53 and 54. Stepped surfaces 508a and 509a are formed because of a diameter difference between the notch 508 and the hollow portion 500 and a diameter difference between the notch 509 and the hollow portion 500, respectively.

The first lid body 53 is inserted into the notch 508 from the axial end surface 50c on the first opening portion 50a side, and an end portion of the first lid body 53 on the outer peripheral side is disposed to face the stepped surface 508a. Meanwhile, the second lid body 54 is inserted into the notch 509 from the axial end surface 50d on the second opening portion 50b side, and an end portion of the second lid body 54 on the outer peripheral side is disposed to face the stepped surface 509a. The axial end surfaces 50c and 50d are each clinched at two locations. FIG. 5 illustrates two clinched portions 50f on the axial end surface 50d on the right side of the drawing. As with the axial end surface 50d, the axial end surface 50c on the first opening portion 50a side is also formed with two clinched portions 50e.

The number of the clinched portions 50e and 50f is not limited to two, and may be three or more. An annular clinched portion may be formed over the entire circumference of the axial end surfaces 50c and 50d in order to fix the first and second lid bodies 53 and 54.

The clinched portion 50f on the second opening portion 50b side is formed by pushing a tool 8 that has a sharp blade tip 81 against the axial end surface 50c as illustrated in FIG. 6 on the left side, for example. A cut-up protrusion 50h formed by cutting up a part of the body 50 at the second opening portion 50b is generated by this clinching process. The cut-up protrusion 50h prevents the second lid body 54 from slipping off from the notch 509. The clinched portion 50e on the first opening portion 50a side is also formed similarly. A cut-up protrusion 50g generated by the clinching process prevents the first lid body 53 from slipping off from the notch 508.

Also with the second embodiment, as with the first embodiment, the support shaft 5A can be manufactured easily, and the weight of the support shaft 5A can be reduced. Since the first and second lid bodies 53 and 54 are not subjected to the clinching process, the amount of lubricating oil that leaks out through the first and second opening portions 50a and 50b because of deformation of the first and second lid bodies 53 and 54 is not increased.

While the present disclosure has been described above on the basis of the embodiments, such embodiments do not limit the disclosure according to the claims. It should be noted that all combinations of the characteristics described in relation to the embodiments are not necessarily essential to address the issue of the disclosure. The present disclosure can be modified, as appropriate, without departing from the scope and spirit of the present disclosure.

What is claimed is:

1. A planetary gear support shaft provided in a shaft hole of a planetary gear to support the planetary gear, the planetary gear being disposed between an internal gear and an external gear supported coaxially so as to be rotatable relative to each other, the planetary gear support shaft comprising:
a body being a tubular steel pipe with two open ends; and
a pair of lid bodies that block opening portions at the two ends of the body, wherein
the body has an in-flow hole that allows lubricating oil to flow into a hollow portion between the pair of lid bodies and an out-flow hole through which the lubricating oil is supplied from the hollow portion into the shaft hole.

2. The planetary gear support shaft according to claim 1, wherein the pair of lid bodies are each a thin plate made of metal, each the thin plate being thinner than a wall thickness of the body.

3. The planetary gear support shaft according to claim 1, wherein an outer peripheral portion of the lid bodies is fitted with an annular groove in an inner peripheral surface of the body.

4. The planetary gear support shaft according to claim 3, wherein the lid bodies include curled portions provided at an end portion of the lid bodies on an outer peripheral side and curved arcuately, the lid bodies being restricted from slipping off from the body with the curled portions retained by a protrusion that is adjacent to the annular groove.

5. The planetary gear support shaft according to claim 1, wherein the lid bodies are fixed to the body by clinching an axial end surface of the body.

6. The planetary gear support shaft according to claim 5, wherein:
the body includes stepped surfaces provided at the opening portions at the two ends and provided by a notch, the stepped surfaces being provided between the notch and an inner peripheral surface of the hollow portion; and
an end portion of the lid bodies on an outer peripheral side is disposed to face the stepped surfaces.

7. A planetary gear device comprising:
an internal gear and an external gear supported coaxially so as to be rotatable relative to each other;
a planetary gear disposed between the internal gear and the external gear;
a carrier that supports the planetary gear so as to be rotatable and revolvable; and
a roller bearing that allows the planetary gear to rotate smoothly, wherein:
the carrier includes a frame body provided coaxially with the internal gear and the external gear so as to be rotatable relative to the internal gear and the external gear, and a support shaft attached to the frame body to support the planetary gear;
the support shaft is provided in a shaft hole of the planetary gear to support the planetary gear;
the support shaft includes
a body being a tubular steel pipe with two open ends, and
a pair of lid bodies that block opening portions at the two ends of the body; and
the body has an in-flow hole that allows lubricating oil to flow into a hollow portion between the pair of lid bodies and an out-flow hole through which the lubricating oil is supplied from the hollow portion into the shaft hole.
